(19) United States
(12) Patent Application Publication
(10) Pub. No.: US 2008/0056081 A1
(43) Pub. Date: Mar. 6, 2008

(54) APPARATUS AND METHOD FOR GENERATING TRACKING ERROR SIGNAL

(75) Inventors: Tatsuhiro Otsuka, Suwon-si (KR); Kyung-geun Lee, Seongnam-si (KR); An-sik Jeong, Hwaseong-si (KR); In-joo Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/684,209

(22) Filed: Mar. 9, 2007

(30) Foreign Application Priority Data
Sep. 5, 2006 (KR) 10-2006-85294

(51) Int. Cl. G11B 7/0037

(52) U.S. Cl. 369/47.1

(57) ABSTRACT

An apparatus and method for generating a tracking error signal (TES). A low level TES is prevented from being generated due to noise in an optical disk drive for reproducing a high-density multi-layered optical disk. The apparatus includes: an N-split optical reception element to receive light reflected by a disk loaded in the optical disk drive, a phase difference signal detection module to detect a plurality of phase difference signals using signals output from the N-split optical reception element, a pulse width modulation module to modulate pulse widths of the plurality of phase difference signals so that the pulse widths of the plurality of phase difference signals are magnified, and a difference detector to detect a difference between the plurality of phase difference signals whose pulse widths are modulated and outputting the detected difference as the TES. N may be a positive integer.

### CROSS-REFERENCE TO RELATED APPLICATIONS

This application claims the benefit of Korean Application No. 2006-85294, filed Sep. 5, 2006 in the Korean Intellectual Property Office, the disclosure of which is incorporated herein by reference.

### BACKGROUND OF THE INVENTION

1. Field of the Invention

Aspects of the present invention relate to an apparatus and method for generating a tracking error signal (TES) in an optical disk drive, and more particularly, to an apparatus and method for generating a TES in an optical disk drive for reproducing a high-density multi-layered optical disk.

2. Description of the Related Art

An optical disk drive is a type of optical information storage and reproduction device. A high-density multi-layered optical disk is a disk such as a Digital Versatile Disc (DVD), a High Definition (HD)-DVD, or a Blu-ray Disc (BD). Optical disk drives that reproduce high-density multi-layered optical disks can generate a tracking error signal in a Differential Phase Detection (DPD) method.

FIG. 1 is a block diagram of a conventional tracking error signal (TES) generation apparatus using the DPD method. In the DPD method, a TES is generated based on a phase difference between an A+C signal and a B+D signal in a 4-split optical reception element 100. Light reflected by an optical disk (not shown) is received by the 4-split optical reception element 100. The element 100 has elements A and D in a first row and elements B and C in a second row. Elements A and C are diagonal to each other, as are elements B and D. Signals output from the optical reception elements A and C are added by an adder 111, and signals output from optical reception elements B and D are added by an adder 112. An equalizer 121 emphasizes a high frequency band in a signal output from the adder 111. An equalizer 122 emphasizes a high frequency band in a signal output from the adder 112. A slicer 131 binarizes a signal output from the equalizer 121, and a slicer 132 binarizes a signal output from the equalizer 122.

A phase difference detector 140 detects the phase difference between the A+C signal output from the slicer 131 and the B+D signal output from the slicer 132. If a phase of the A+C signal leads a phase of the B+D signal, the phase difference detector 140 outputs a phase difference signal PD1. If the phase of the A+C signal lags behind the phase of the B+D signal, the phase difference detector 140 outputs a phase difference signal PD2. A subtractor 150 detects a difference between the phase difference signal PD1 and the phase difference signal PD2. A low pass filter (LPF) 160 low pass filters the difference PD1−PD2 output from the subtractor 150. The signal output from the LPF 160 is the TES.

FIG. 2 illustrates an operational timing diagram of the tracking error signal generation apparatus illustrated in FIG. 1. The diagram shows the A+C signal detected from the adder 111, the B+D signal detected from the adder 112, the PD1 and PD2 detected from the phase difference detector 140, and the TES output from the LPF 160.

When an optical disk drive for reproducing a high-density multi-layered optical disk generates a TES as illustrated in FIG. 1, a signal to noise (S/N) ratio of each of the signals output from the optical reception elements A, B, C, and D may be worse due to noise. If the S/N ratios of the signals output from the optical reception elements A, B, C, and D are worse, the phase difference detector 140 may not correctly detect PD1 or PD2. If neither PD1 nor PD2 are detected, a level of the TES (or DPD signal) output from the LPF 160 is low.

FIG. 3 illustrates simulation examples of the TES generated by the tracking error signal generation apparatus illustrated in FIG. 1 according to a white noise level. The levels of white noise are 40, 100, 200, 300, and 400 mV. An increase of the white noise level results in a decrease of the level of the TES. A correlation between the noise level and the level of the TES is shown in FIG. 4.

If the level of the generated TES is low, the margin of a servo system is narrow, decreasing the stability of the optical disk drive.

### SUMMARY OF THE INVENTION

Aspects of the present invention provide an apparatus and method for generating a tracking error signal (TES), whereby the TES having a low level is prevented from being generated due to noise in an optical disk drive for reproducing a high-density multi-layered optical disk.

Additional aspects and/or advantages of the invention will be set forth in part in the description which follows and, in part, will be obvious from the description, or may be learned by practice of the invention.

According to an aspect of the present invention, there is provided an apparatus for generating a tracking error signal (TES) in an optical disk drive, the apparatus comprising: an N-split optical reception element to receive light reflected by a disk loaded in the optical disk drive, wherein N is a positive integer; a phase difference signal detection module to detect a plurality of phase difference signals using signals output from the N-split optical reception element; a pulse width modulation module to modulate pulse widths of the plurality of phase difference signals so that the pulse widths of the plurality of phase difference signals are magnified; and a difference detector to detect a difference between the plurality of phase difference signals whose pulse widths are modulated and outputting the detected difference as the TES.

According to another aspect of the present invention, there is provided a method of generating a tracking error signal (TES) in an optical disk drive, the method comprising: outputting signals based on light reflected by a disk loaded in the optical disk drive; detecting a plurality of phase difference signals using the output signals; modulating pulse widths of the plurality of phase difference signals so that the pulse widths of the plurality of phase difference signals are magnified; and generating a difference between the plurality of phase difference signals whose pulse widths are modulated.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional tracking error signal (TES) generation apparatus using a Differential Phase Detection (DPD) method;

FIG. 2 illustrates an operational timing diagram of the tracking error signal generation apparatus illustrated in FIG. 1;

FIG. 3 illustrates simulation examples of a TES (or DPD signal) generated by the tracking error signal generation apparatus illustrated in FIG. 1 according to a white noise level;

FIG. 4 illustrates a correlation between a noise level and a level of the TES;

FIG. 5 is a block diagram of a TES generation apparatus according to an embodiment of the present invention;

FIG. 6 is a block diagram of a phase difference signal detection module illustrated in FIG. 5, according to an embodiment of the present invention;

FIG. 7 is a block diagram of a pulse width modulation module illustrated in FIG. 5 for a single phase difference signal, according to an embodiment of the present invention;

FIG. 8 is a graph showing a level of a TES when a pulse width is changed from 0T to 2T, according to an embodiment of the present invention;

FIG. 9 illustrates an operational timing diagram of the pulse width modulation module illustrated in FIG. 5, according to an embodiment of the present invention;

FIG. 10 is a graph comparing levels of a TES generated by the conventional TES generation apparatus illustrated in FIG. 1 using the DPD method to levels of a TES generated by the TES generation apparatus illustrated in FIG. 5;

FIG. 11A illustrates simulation of levels of a TES generated in a conventional method.

FIG. 11B is a simulation of levels of a TES generated according to an embodiment of the present invention when white noise is added to signals output from optical reception elements A, B, C, and D; and

FIG. 12 is a flowchart illustrating a TES generation method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 5 is a block diagram of a TES generation apparatus according to an embodiment of the present invention. The TES generation apparatus includes a 4-split optical reception element 501, a phase difference signal detection module 502, a pulse width modulation module 503, and a difference detector 504.

The 4-split optical reception element 501 receives light reflected by a disk (not shown) loaded in an optical disk drive (not shown). The optical reception element 501 may be alternately defined as an N-split optical reception element, wherein N is a positive integer. For example, N may be two or six. The disk may be a high-density multi-layered optical disk.

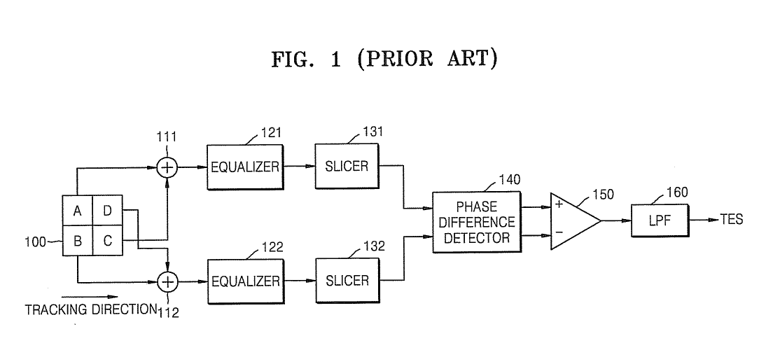

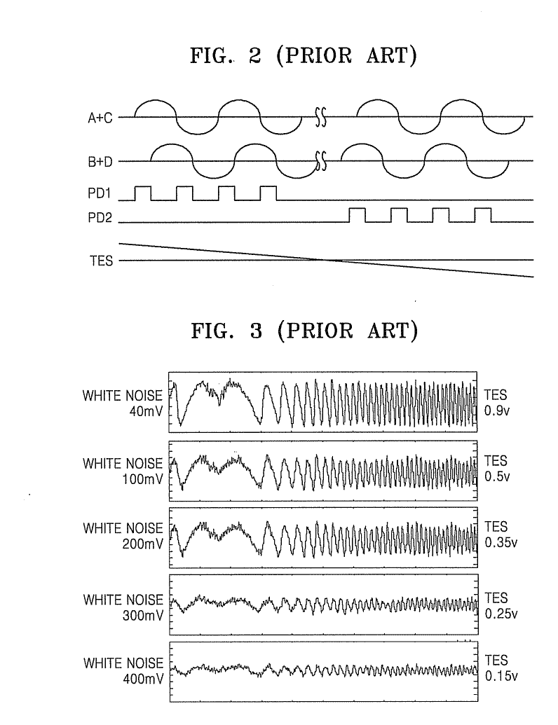

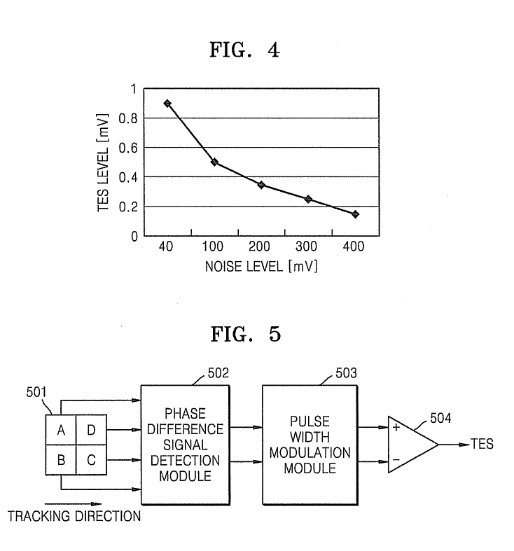

The phase difference signal detection module 502 detects a plurality of phase difference signals based on signals output from optical reception elements A, B, C, and D of the 4-split optical reception element 501. The optical elements A and D are in a first row and optical elements B and C are in a second row. The optical elements A and C are diagonally opposite in a first direction and optical elements B and C are diagonally opposite in a second direction other than the first. The phase difference signal detection module 502 according to some aspects of the present invention may include the components shown in FIG. 1, such as adders 111 and 112, the equalizers 121 and 122, the slicers 131 and 132, and the phase difference signal detector 140. The phase difference signal detector module 502 may also detect the plurality of phase difference signals PD1 and PD2 between A+C and B+D.

The phase difference signal detection module 502 can also be configured to detect a plurality of phase difference signals between the optical reception elements A and B and a plurality of phase difference signals between the optical reception elements C and D. In the embodiment shown in FIG. 5, four phase difference signals are output from the phase difference signal detection module 502.

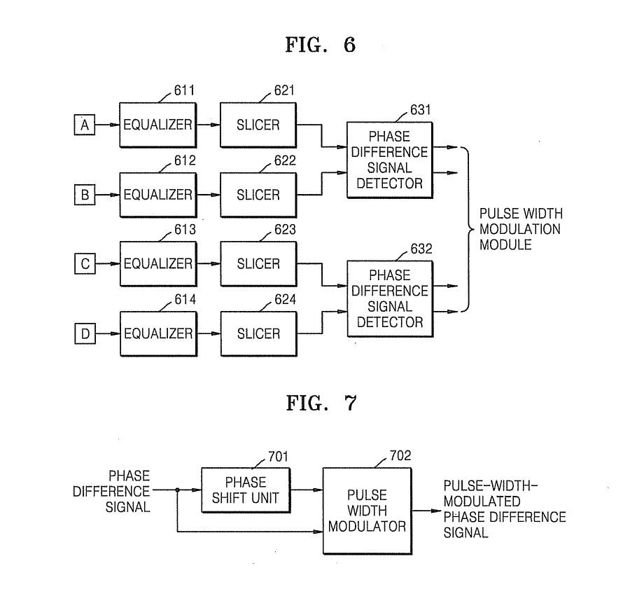

The phase difference signal detection module 502 can be configured as illustrated in FIG. 6. FIG. 6 is a block diagram of the phase difference signal detection module 502 illustrated in FIG. 5, according to an embodiment of the present invention. The phase difference signal detection module 502 includes equalizers 611, 612, 613, and 614, and slicers 621, 622, 623, and 624 for the respective optical reception elements A, B, C, and D. A phase difference signal detector 631 detects a plurality of phase difference signals between a signal output from the slicer 621 corresponding to the optical reception element A and a signal output from the slicer 622 corresponding to the optical reception element B. A phase difference signal detector 632 detects a plurality of phase difference signals between a signal output from the slicer 623 corresponding to the optical reception element C and a signal output from the slicer 624 corresponding to the optical reception element D.

According to an aspect of the invention, the correlation between the plurality of phase difference signals output from the phase difference signal detector 631 is the same as the correlation between the plurality of phase difference signals PD1 and PD2 described above with respect to FIG. 1. That is, the plurality of phase difference signals output from the phase difference signal detector 631 are phase difference signals distinguished according to whether a phase of a signal output from the optical reception element A leads or lags behind a phase of a signal output from the optical reception element B.

Similarly, the correlation between the plurality of phase difference signals output from the phase difference signal detector 632 is the same as the correlation between the plurality of phase difference signals PD1 and PD2 described above with respect to FIG. 1. That is, the plurality of phase difference signals output from the phase difference signal detector 632 are phase difference signals distinguished according to whether a phase of a signal output from the optical reception element C leads or lags behind a phase of a signal output from the optical reception element D.

Referring back to FIG. 5, the pulse width modulation module 503 modulates pulse widths of the plurality of phase difference signals output from the phase difference signal detection module 502 so that each of the pulse widths is magnified. To do this, an embodiment of the pulse width modulation module 503 shown in FIG. 7 includes one phase shift unit 701 and one pulse width modulator 702 per input phase difference signal. For example, if, as shown in FIG. 5, two phase difference signals are input to the pulse width modulation module 503, the pulse width modulation module 503 can include two pairs of phase shift units 701 and pulse width modulators 702 for the two input phase difference signals. If four phase difference signals are input to the pulse width modulation module 503, the pulse width modulation module 503 can include four pairs of phase shift units 701 and pulse width modulators 702 for the four input phase difference signals.

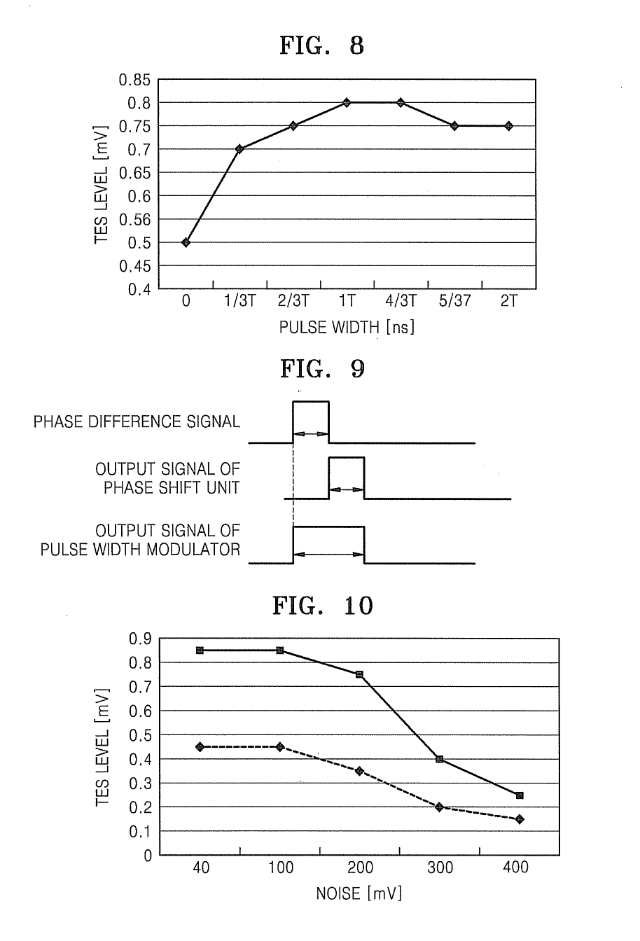

FIG. 7 is a block diagram of the pulse width modulation module 503 illustrated in FIG. 5 for a single phase difference signal, according to an embodiment of the present invention. The phase shift unit 701 shifts a phase of an input phase difference signal. The amount of shifted phase may be pre-set. The pre-set amount of shifted phase can be set according to a pulse width to be magnified. The pulse width to be magnified can be determined based on the pulse width where the level of the TES (or DPD signal) is maximal. FIG. 8 is a graph showing the level of the TES when a pulse width is changed from 0T to 2T, according to an embodiment of the present invention. As can be seen in FIG. 8, the TES is highest at a pulse width of 1T.

The pulse width modulator 702 modulates a pulse width of the input phase difference signal based on the input phase difference signal and a phase difference signal whose phase is shifted, which is output from the phase shift unit 701, so that the pulse width of the input phase difference signal is magnified. FIG. 9 illustrates an operational timing diagram of the pulse width modulation module 503 illustrated in FIG. 5, according to an embodiment of the present invention. If the phase shift unit 701 outputs a phase difference signal in which the phase of the input phase difference signal is shifted, the pulse width modulator 702 outputs a phase difference signal whose pulse width is magnified. The pulse width modulator 702 magnifies the pulse width by adding the input phase difference signal to the phase-shifted phase difference signal. Thus, as shown, a leading edge of the magnified pulse is the leading edge of the phase difference signal and a trailing edge of the magnified pulse is the trailing edge of the phase-shifted difference signal.

Referring back to FIG. 5, the difference detector 504 detects a difference between pulse-width-modulated phase difference signals. For example, if PD1 and PD2 are output from the phase difference signal detection module 502 and pulse-width-modulated PD1′ and PD2′ are output from the pulse width modulation module 503, the difference detector 504 outputs a difference (PD1′−PD2′) between PD1′ and PD2′. A signal output from the difference detector 504 is generated as the TES. The TES can be defined as a DPD signal. The TES generation apparatus illustrated in FIG. 5 can further include a low pass filter (not shown) low pass filtering the signal output from the difference detector 504 and outputting the low pass filtered signal as the TES.

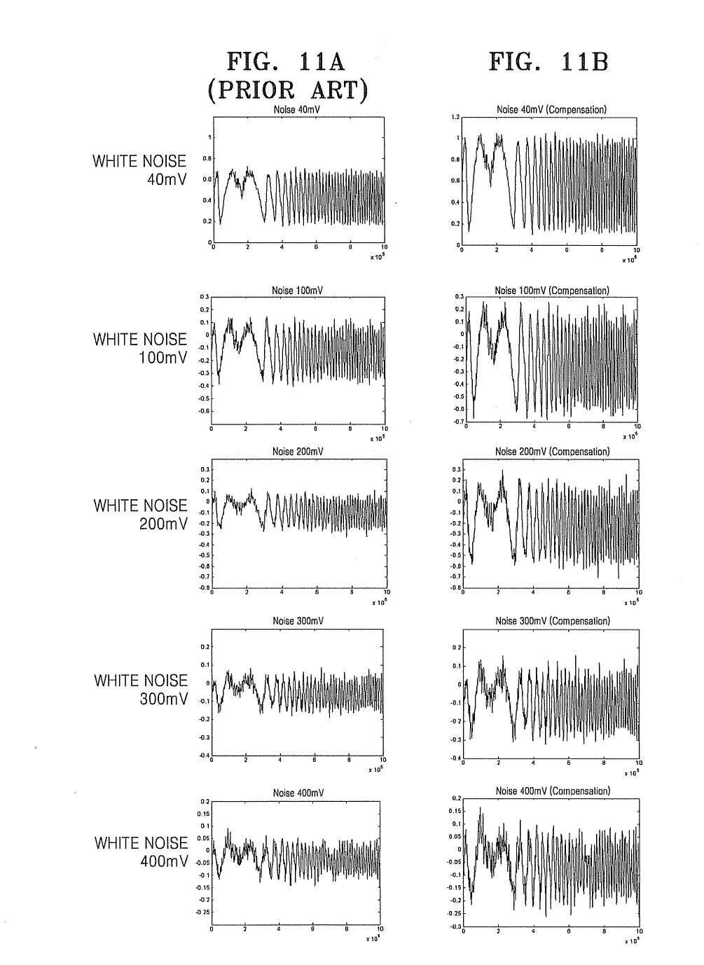

FIG. 10 is a graph comparing levels of the TES generated by a conventional TES generation apparatus using the DPD method as shown in FIG. 1 to levels of the TES generated by the TES generation apparatus illustrated in FIG. 5. The solid line indicates the levels of the TES generated by the TES generation apparatus illustrated in FIG. 5. The dotted line indicates the levels of the TES generated by the conventional TES generation apparatus using the DPD method shown in FIG. 1. As FIG. 10 illustrates, by generating the TES according to aspects of the present invention, even if noise is added to the signals output from the optical reception elements A, B, C, and D, the level of the TES output from the TES generation apparatus illustrated in FIG. 5 is about twice the level of a TES output from the conventional TES generation apparatus of FIG. 1.

FIG. 11A illustrates a simulation example of the levels of the TES generated according to the conventional method. FIG. 11B illustrates a simulation example of the levels of the TES generated according to an embodiment of the present invention when white noise is added to signals output from the optical reception elements A, B, C, and D as similarly illustrated in FIG. 3. When noise is added to the signals output from the optical reception element 100 or 501, the levels of the TES are higher when the TES is generated according to an embodiment of the present invention than when the TES is generated according to the conventional method.

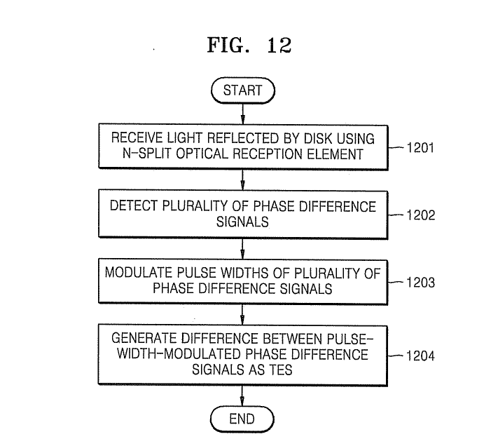

FIG. 12 is a flowchart illustrating a TES generation method according to an embodiment of the present invention. Light reflected by a disk loaded in an optical disk drive is received using an N-split optical reception element included in the optical disk drive in operation 1201. The N-split optical reception element can be, for example, the 4-split optical reception element 501 illustrated in FIG. 5. A plurality of phase difference signals are detected using signals output from the N-split optical reception element in operation 1202. The detected plurality of phase difference signals may be PD1 and PD2 shown in FIG. 5 or phase difference signals corresponding to PD1 and PD2.

Pulse widths of the plurality of phase difference signals are modulated in operation 1203 so that a pulse width of each of the plurality of phase difference signals is magnified. The phase of each of the plurality of phase difference signals is shifted by an amount such as that illustrated in FIG. 7. The pulse widths of the plurality of phase difference signals detected in operation 1202 are modulated by adding the detected plurality of phase difference signals to the plurality of phase-shifted phase difference signals.

A difference between the pulse-width-modulated phase difference signals is detected by the difference detector 504 illustrated in FIG. 5 and the detected difference is generated as a TES in operation 1204. The TES generation method illustrated in FIG. 12 can be modified to further include low pass filtering the difference between the pulse-width-modulated phase difference signals, which is detected in operation 1204, and generating the low pass filtered signal as the TES.

Aspects of the present invention can also be embodied as computer readable codes on a computer readable recording medium. The computer readable recording medium may be any data storage device that can store data which can be thereafter read by a computer system. Examples of computer readable recording media include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to aspects of the present invention, by improving the generation of a TES of a low level due to noise in an optical disk drive for reproducing a high-density multi-layered optical disk, even if noise is added to a reproduced signal, the TES can be generated more accurately, and stability of the optical disk drive against noise can be increased.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for generating a tracking error signal (TES) in an optical disk drive, the apparatus comprising:
an N-split optical reception element to receive light reflected by a disk loaded in the optical disk drive, wherein N is a positive integer;
a phase difference signal detection module to detect a plurality of phase difference signals using signals output from the N-split optical reception element;
a pulse width modulation module to modulate pulse widths of the plurality of phase difference signals to magnify the pulse widths to produce magnified phase difference signals; and
a difference detector to detect a difference between the magnified plurality of phase difference signals and to output the detected difference.

2. The apparatus according to claim 1, wherein the pulse width modulation module comprises:
a phase shift unit to shift a phase of a first phase difference signal output from the phase difference signal detection module and to output the phase shifted first phase difference signal as a second phase difference signal; and
a pulse width modulator to modulate a pulse width of the first phase difference signal based on the first phase difference signal and the second phase difference signal;
wherein the pulse width modulation module comprises one phase shift unit and one pulse width modulator for each of the plurality of phase difference signals output from the phase difference signal detection module.

3. The apparatus according to claim 2, further comprising a low pass filter to low pass filter the difference detected by the difference detector and to output the low pass filtered signal as the TES.

4. The apparatus according to claim 1, further comprising a low pass filter to low pass filter the difference detected by the difference detector and to output the low pass filtered signal as the TES.

5. A method of generating a tracking error signal (TES) in an optical disk drive, the method comprising:
outputting signals based on light reflected by a disk loaded in the optical disk drive;
detecting a plurality of phase difference signals using the output signals;
modulating pulse widths of the plurality of phase difference signals to magnify the pulse widths to produce a plurality of magnified phase difference signals; and
generating a difference between the magnified phase difference signals.

6. The method according to claim 5, wherein the modulating of the pulse widths comprises modulating the pulse widths of the plurality of phase difference signals using the plurality of phase difference signals as well as phase difference signals obtained by shifting a phase of each of the plurality of phase difference signals.

7. The method according to claim 6, further comprising:
low pass filtering the generated difference between the plurality of phase difference signals; and
outputting the low pass filtered signal as the TES.

8. The method according to claim 5, further comprising:
low pass filtering the difference between the plurality of phase difference signals; and
outputting the low pass filtered signal as the TES.

9. An apparatus comprising:
a pulse width modulation module to modulate pulse widths of a plurality of phase difference signals to magnify the pulse widths to produce a plurality of magnified phase difference signals, the plurality of phase difference signals being generated using signals from light reflected by an optical disk loaded in an optical disk drive; and
a tracking error signal generator to generate a tracking error signal using differences between the magnified phase difference signals.

10. The apparatus according to claim 9, wherein the pulse width modulation module comprises:
a phase shift unit to shift a phase of a first phase difference signal output from the phase difference signal detection module; and
a pulse width modulator to modulate a pulse width of the first phase difference signal based on the first phase difference signal and a second phase difference signal obtained by shifting a phase of the first phase difference signal;
wherein the pulse width modulation module comprises one phase shift unit and one pulse width modulator for each of the plurality of phase difference signals output from the phase difference signal detection module.

11. The apparatus according to claim 10, wherein the pulse width modulator modulates the pulse width of the first phase difference signal by adding the first phase difference signal and the second phase difference signal.

12. The apparatus according to claim 10, wherein the phase shift unit generates the second phase difference signal by shifting the phase of the first phase difference signal by a predetermined amount.

13. The apparatus according to claim 2, wherein the pulse width modulator modulates the pulse width of the first phase difference signal by adding the first phase difference signal and the second phase difference signal.

14. The apparatus according to claim 2, wherein the pulse width modulator generates the second phase difference signal by shifting the phase of the first phase difference signal by a predetermined amount.

15. The method according to claim 6, wherein the modulating of the pulse widths further comprises adding the plurality of phase difference signals to the second phase difference signals.

16. The method according to claim 6, wherein the second phase difference signals are obtained by shifting the phase of the plurality of phase difference signals by a predetermined amount.

17. A recording and/or reproducing apparatus to transfer data with respect to an information recording medium, the apparatus comprising:
a pulse width modulation module to modulate pulse widths of a plurality of phase difference signals to magnify the pulse widths to produce a plurality of magnified phase difference signals, the plurality of phase difference signals being generated using signals from light reflected by an optical disk loaded in an optical disk drive;
a tracking error signal generator to generate a tracking error signal using differences between the magnified phase difference signals;
an optical pickup to transfer the data with respect to the information recording medium; and
a controller to control the optical pickup according to the generated tracking error signal.
